(19) United States
(12) Patent Application Publication
(10) Pub. No.: US 2019/0011725 A1
(43) Pub. Date: Jan. 10, 2019

(54) Elastic Rim Lock Without Screws For Eyeglasses Operating As Hinge And Temple

(71) Applicant: Dijana Kacavenda, Pieve Di Cadore (BL) (IT)

(72) Inventor: Dijana Kacavenda, Pieve Di Cadore (BL) (IT)

(21) Appl. No.: 16/067,593

(22) PCT Filed: Dec. 1, 2017
(86) PCT No.: PCT/IT2017/000002

§ 371 Date: Jun. 30, 2018

(30) Foreign Application Priority Data
Jan. 21, 2016 (IT) 102016000004906

(51) Int. Cl. G02C 5/22

(52) U.S. Cl. CPC G02C 5/2209; G02C 2200/24

(57) ABSTRACT

An elastic rim lock without screws for eyeglasses operating as hinge and temple is described, comprising: a spring, a first front frame part, a second front frame part and a cut, the spring being tensioned between a head of the wire and a surface of a first seat of the second front frame part separated by the cut, the rim lock further comprising a wire, a first segment of the wire passing through the spring, the first seat, a second seat of the second front frame part and a seat of the first front frame part, while a second segment of the wire is in permanent contact with a surface of the first front frame part and has the function of defining the length of the first segment, a section of the wire being configured for being a temple or a temple core.

The present invention refers to an elastic rim lock without screws for eyeglasses operating as hinge and temple.

The present invention deals with flexible rim lock and hinge arrangements for eyeglasses which allow an efficient elastic articulation between temple and front frame, with low manufacturing and assembling costs for the eyeglasses.

Known rim locks for eyeglasses have some inconveniences, among which the need of using screws, the difficulty of perfectly matching the two parts of the rim, high costs both for manufacturers and for the public, a difficulty for the optician to assemble the lenses, chance by an unskilled person to disassemble the lenses to clean and sanitize the eyeglass, a difficulty when treating materials such as aluminium and titanium.

Eyeglasses are known which are made of materials which cannot be welded or for which welding is costly and unreliable.

The art has rim locks which are closed through screws, to which hinges are fastened through screws or rivets. A thread is made in the material and the rim lock is fastened through a screw, making the operation costly and unaesthetic.

The rim lock is made on the part of the face or the temple.

On a thread made of aluminium: the screws can be unscrewed with difficulty, and once unscrewed have not the same grip: consequently, an optician does not want to purchase this type of eyeglasses. When painting, the screws are painted and consequently the small channel is closed, thereby preventing the entry of a screwdriver. During the screwing and unscrewing steps, it often happens that the screwdriver slips from the seat of the screw, creating permanent damages to the paint; moreover, the screwdriver can scrap the lenses.

From searches, it does not appear that there is a rim lock which can be easily widened and cleaned by the end user to clean and sanitize the eyeglass, and which performs the function of temple or of core on which the temple is assembled.

FR-A-1 470 276 discloses a rim lock according to the preamble of claim 1.

Object of the present invention is solving the above prior art problems, by providing an elastic rim lock without screws for eyeglasses operating as hinge and temple, which can be easily manufactured and immediately assembled; can ensure a positioning stability between the two parts of the rim; can be applied on different types of materials (among which aluminium, titanium, acetate plastics, injected plastics, wood and other metallic alloys); is elastic and without screws; can be opened wide to allow the user to assemble and disassemble the lenses autonomously; has the technical change of extracting the lens from the rim to remove dirt and thereby allow the end user to clean and sanitize the eyeglass.

The above and other objects and advantages of the invention, as will appear from the following description, are obtained with an elastic rim lock without screws as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

The present invention will be better described by some preferred embodiments thereof, provided as a non-limiting example, with reference to the enclosed drawings, in which:

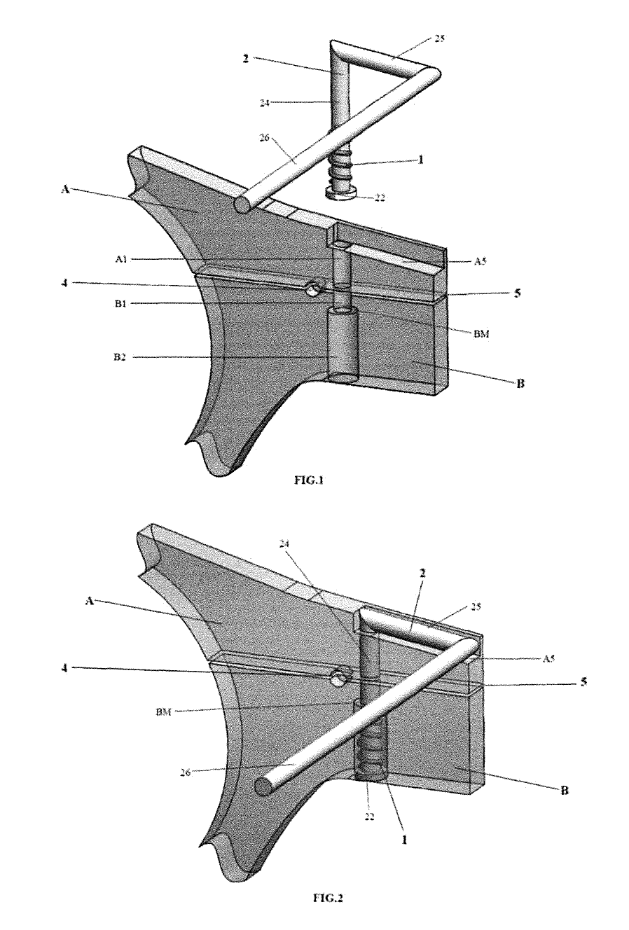

FIG. 1 is a perspective view on an enlarged scale of a first preferred embodiment of the rim lock of the present invention in a disassembled condition;

FIG. 2 is a perspective view on an enlarged scale of the rim lock of FIG. 1 in the phase in which a lens is assembled according to the present invention;

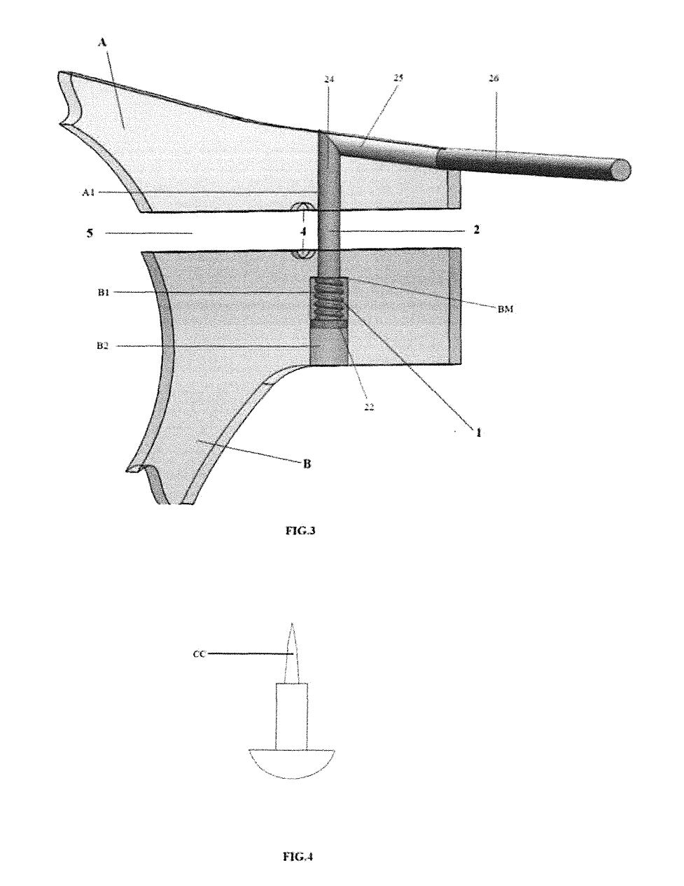

FIG. 3 is a perspective view on an enlarged scale of the rim lock of FIG. 1 in its phase of maximum opening according to the present invention;

FIG. 4 is a front view on an enlarged scale of the conical body (CC) of the rim lock of FIG. 1;

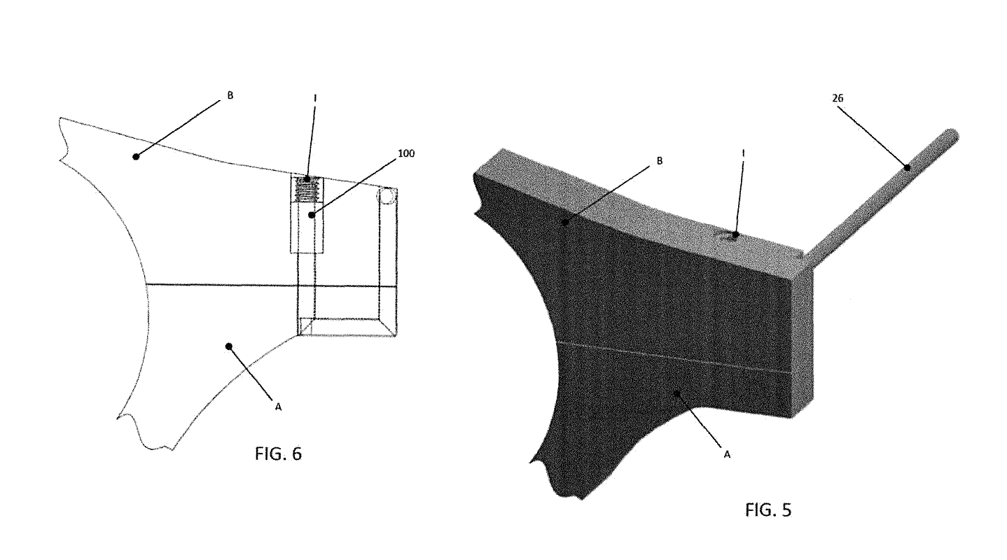

FIG. 5 is a perspective view in an enlarged scale of a second preferred embodiment of the elastic rim lock of the present invention; and

FIG. 6 is a side view of the elastic rim lock of FIG. 5.

With reference to the Figures, the present invention allows making a rim lock for full circles for which, upon assembling the lens in the front frame, no screw has to be unscrewed and screwed.

The present invention, moreover, makes the two parts of the front frame perfectly coincide, once having closed the front frame.

Moreover, a rim lock is obtained, which widens itself when assembling the lens and is then automatically closed again, remaining safe and reliable.

The rim lock of the invention is invisible and completely hidden in the material of its front frame.

A rim lock is obtained with a flexible and permanent automatic seal, and which has enough force to keep the lens stable.

The rim lock of the invention can be widened enough to be able to disassemble the lens in a simple and understandable way also by unskilled people.

The rim lock of the invention allows the end user to wholly sanitize the eyeglass, above all in points which are usually impossible to reach (small channel, etc.).

This rim lock closes without an optician using the screws.

This rim lock also performs the function of hinge and temple.

The temple is pusher towards a part of the front frame, in order to obtain a permanent but flexible pressure, in order to guarantee a frictional sliding when opening and closing the temple.

The rim lock of the invention has a low cost but is at the same time reliable, stable and with the pieces composing the mechanical parts hidden in the front frame.

This rim lock is made of: aluminium, titanium, wood, horn, magnesium and all other materials which can be welded with difficulty or whose welding costs too much.

It will be possible to combine various materials together, because the material of the rim lock does not depend in any way on the material of the front frame.

Once having inserted the conical body into its suitable hole, the end user or unskilled person in this field is able to wash and sanitize the whole eyeglass.

The elastic rim lock without screws for eyeglasses operating as hinge and temple of the invention is composed of: a spring (1), a titanium wire (2), a first front frame part (A), a second front frame part (B), a hole (4) and a cut (5).

In the first front frame part (A) a seat (A1) is obtained.

In the second front frame part (B) a seat is obtained, composed of two holes/seats (B1, B2) with different diameters.

The first and second front frame parts (A, B) are divided by the cut (5).

The first seat (B2) ha a greater diameter with respect to the external diameter of the spring (1) and to the external diameter of the head (22).

On the top of the titanium wire (2) a head (22) is made. Part of the titanium wire (2) coincides with the second segment (25), which is always in flexible contact with the surface (A5) obtained in the first front frame part (A) of the front frame. The first segment (24) is housed in the seats (A1) (B1) (B2). The segment (26) functions as temple.

The seats (A1), (B1) have a diameter just greater than the external diameter of the titanium wire (2).

The spring (1) is tensioned between the head (22) of the titanium wire (2) and the end (BM) of the first seat (B2).

The seats (A1) and (B1) have also the function of always guaranteeing a perfect coincidence between the first and second front frame parts (A) and (B).

The first and second front frame parts (A) and (B) are always mutually in flexible contact, and if exposed to a bigger force with respect to the spring force, can be opened wide upon assembling the lens. In this step, the second front frame part (B) moves away from the first front frame part (A) and a longitudinal displacement of the first seat (B2) occurs with respect to the head (22) of the titanium wire (2) and the spring, further forced between the head (22) and the end (BM) of the first seat (B2). The same wide-opening effect occurs when a conical body (CC) is inserted into the hole (4).

The hole (4) is milled on the cut (5) and its function is housing the conical body (CC), to allow the elastic opening of the rim of the eyeglass.

The first front frame part (A) and the second front frame part (B) are in permanent flexible contact. The spring (1) is tensioned between the head (22) of the wire (2) and the surface (BM) of the first seat (B2). The diameter of the head (22) and the external diameter of the spring (1) are lower than the diameter of the first seat (B2) and longitudinally slide with respect to the axis of the first seat (B2) when the first front frame part (A) and the second front frame part (B) move one apart from the other. The first segment (24) of the wire (2) passes through the spring (1), the first seat (B2), the second seat (B1) and the seat (A1). The second segment (25) is in permanent contact with the surface (A5) of the part of first front frame part (A) and has the function of defining the length of the first segment (24). The cut (5) is made between the seat (A1) and the second seat (B1). The part (26) of the wire (2) functions as temple or temple core. The rim lock has a hole (4) which is on the cut (5). The size of the external diameter of the conical body (CC) is equal to the stroke of the spring (1).

As regards the assembly of the rim lock, the spring (1) is placed around the titanium wire (2) till it gets to the head (22) of the titanium wire (2). The titanium wire (2) passes through the seats (B2), (B1), (A1) till the head (22) wholly enters in the front frame.

The titanium wire (2) is bent in order to coincide with the surface (A5).

The titanium wire (2) is bent to create the segment (26) which works as temple.

The hole is made on the cut (5). In the hole (4) the conical body (CC) is inserted, to allow a easier opening of the rim.

When the conical body (CC) is inserted in the hole (4), the spring (1) is compressed and the first front frame part (A) moves away from the second front frame part (B), making it possible to open the rim also by unskilled people in the field.

Summarizing, the invention deals with an elastic rim lock without screws for eyeglasses operating as hinge and temple comprising: a spring (1), a first front frame part (A), a second front frame part (B) and a cut (5), which longitudinally separates the first front frame part (A) from the second front frame part ((B), the first front frame part (A) and the second front frame part (B) being in permanent flexible contact, the spring (1) being tensioned between a head (22) of the wire (2) and a surface (BM) of a first seat (B2) of the second front frame part (B), the diameter of the head (22) and the external diameter of the spring (1) being lower than the diameter of the first seat (B2) and longitudinally sliding with respect to an axis of the first seat (B2) when the first front frame part (A) and the second front frame part (B) move away one from the other.

The above elastic rim lock further comprises a wire (2), a first segment (24) of the wire (2) passing through the spring (1), the first seat (B2), a second seat (B1) of the second front frame part (B) operatively connected to the first seat (B2) and having a smaller diameter than the first seat (B2), and a seat (A1) of the first front frame part (A), while a second segment (25) of the wire (2) is in permanent contact with a surface (A5) of the first front frame part (A) parallel to an axis of the cut (5), and has the function of defining the length of the first segment (24), a section (26) of the wire (2) being configured to be a temple or a temple core, the cut (5) being made between the seat (A1) and the second seat (B1), the second seat (B1).

In particular, the elastic rim lock has a hole (4) which is on the cut (5), the hole (4) having the function of housing a conical body (CC) to allow the elastic opening of the rim of the eyeglass, the size of the external diameter of the conical body (CC) being equal to a stroke of the spring (1).

According to the variation shown in FIGS. 5 and 6, the rim lock of the invention further comprises a nut (100) placed in place of the head (22) of the wire (2), such nut (100) allowing to tension the spring (1) in order to be able to previously bend the wire (2) and then assemble it on the rim lock. This arrangement allows solving the manufacturing problem for which, by bending the wire (2) on the front frame of the eyeglass, it I s necessary to pay attention not to damage the painting, and this strongly slows down the manufacturing cycle.

In this way, instead the temple (26) or the wire (2) already frictioned can be used as core to be able to coat it with any other material, for example titanium, plastics, rubber, wood, etc.

1-3. (canceled)

4. An elastic rim lock without screws for eyeglasses operating as hinge and temple comprising:
a) a spring;
b) a first front frame part;
c) a second front frame part; and
d) a cut, which longitudinally separates the first front frame part from the second front frame part, wherein the first front frame part and the second front frame part being in permanent flexible contact.

5. The elastic rim lock of claim 1, wherein the spring is tensioned between a head of a wire and a surface of a first seat of the second front frame part.

6. The elastic rim lock of claim 5, wherein the diameter of the head and an external diameter of the spring being lower than a diameter of the first seat and longitudinally sliding with respect to an axis of the first seat when the first front frame part and the second front frame part move away one from the other

7. The elastic rim lock of claim 6, further comprising:
a) a wire, where a first segment of the wire passes through the spring, the first seat;
b) a second seat of the second front frame part operatively connected to the first seat and having a smaller diameter than the first seat;
c) a seat of the first front frame part, where a second segment of the wire is in permanent contact with a surface of the first front frame part parallel to an axis of the cut, and has the function of defining the length of the first segment; and
d) a third section of the wire being configured to be a temple or a temple core, the cut being made between the seat and the second seat, the second seat.

8. Elastic rim lock according to claim 1, further comprising a hole that is on the cut, where the hole houses a conical body that has an elastic opening of the rim of the eyeglass, the size of the external diameter of the conical body being equal to a stroke of the spring.

9. Elastic rim lock according to claim 8, further comprising a nut placed in place of the head of the wire, the nut is used to tension the spring in order to be able to previously bend the wire and then assemble it on the rim lock.

10. Elastic rim lock according to claim 1, further comprising a nut placed in place of the head of the wire, the nut is used to tension the spring in order to be able to previously bend the wire and then assemble it on the rim lock.
